(19) United States
(12) Patent Application Publication
(10) Pub. No.: US 2007/0271228 A1
(43) Pub. Date: Nov. 22, 2007

(54) Documentary search procedure in a distributed system

(76) Inventor: Laurent Querel, Nanterre (FR)

Correspondence Address: ST. ONGE STEWARD JOHNSTON & REENS, LLC, 986 BEDFORD STREET, STAMFORD, CT, 06905-5619, US

(21) Appl. No.: 11/435,603

(22) Filed: May 17, 2006

(51) Int. Cl. G06F 17/30

(52) U.S. Cl. 707/3

(57) ABSTRACT

The current invention concerns a document search procedure in a distributed information system, containing construction steps of a thematic representation made up of: constructing, on user computers, the thematic categories; constructing at least one grouping index, a first grouping index containing the entries Ei made up of all the access links Ui of the documentary resources, a second grouping index containing the entries Ei made up of all the descriptors Ki of the categories Ci, and the search steps consisting of extracting the grouping index of the categories to establish a suggestion list Sj made up of the access links Uj ordered as a function of a representative score of importance and/or of number of occurrences of the link Uj in the categories Cj.

### FIELD OF THE INVENTION

The current invention relates to the field of document searching and particularly searching numerical documentation stored in a distributed information system, connected by a network of the Internet type.

### BACKGROUND OF THE INVENTION

Document searching is traditionally carried out by search engines using a centralized index which continually explores numeric resources and can be queried to retrieve a list corresponding to a keyword search and provide access to listed documents as hypertext links.

This solution has drawbacks. In particular, it requires extensive mass storage to stock the centralized index and involves a long processing time. The solution aims for an exhaustive exploration and does not take into account users' judgment.

Another existing solution aims to facilitate document access through accessing the favorites of multiple users who share the same interests. This solution set out in the patent US2002/16786 involves keyword search to identify documents belonging to the group of users corresponding to the keyword. The query is carries out on the common profile of a group, and allows access to the documents of the subset of the favorites of the group members.

This solution is not totally satisfactory because the result is very dependent on the pertinence of the search criteria and possible confusion of the target keyword, due to synonym issues, polysemy, language and spelling.

### SUMMARY OF THE INVENTION

Responding to these drawbacks this invention concerns broadly speaking a document search procedure over a distributed information system, made up of steps to construct a thematic representation consisting of:

Constructing on the user's platform, thematic categories each containing at least one link to a document resource Ui, each category being associated with a descriptor Ci, the resources Ui of a category being considered by the user as homogenous by their thematic content and associated with at least one descriptor Ki;

Constructing at least one grouping index,
A first grouping includes the entries Ei made up of all the links Ui to the documentation resources, each entry Ei being associated with at least one category Ci of this access link Ui,
A second grouping index includes the entries Ei formed from the descriptors Ki of the categories Ci made up of these access links Ui of the documentary resources, each entry Ei being associated with at lest one category Ci of the access links Ui,
and the search steps consist of extracting from the aforementioned grouping indexes the categories Cj associated with at lest one entry Ej corresponding to the search criteria Qj and to establish a list of suggestions Sj made up of the access links Uj ordered using a score representing the importance and/or number of occurrences of the link Uj in the aforementioned categories Cj.

In one embodiment of the invention, the description of the category Ci is made up of the identification of the user originating the category Ci.

In another embodiment, the descriptor of the category Ci is made up of a coefficient representing the degree of pertinence of the category.

In a third embodiment, the descriptor of the category Ci is made up of an identifier of at least one set to which the category Ci belongs to.

In a fourth embodiment, the category description Ci is made up of at least one identifier of a link Ui belonging to the category ci.

In addition, the search criteria Qj corresponds to at least one address saved in at least one category Cj.

In one embodiment, the search criteria Qj corresponds to the address of the page currently being consulted.

In another embodiment, the search criteria Qj corresponds to at least one address present in the contents of the page being consulted.

In another embodiment, the search criteria Qj corresponds to at least one keyword present in a form or a page being consulted.

In a particular implementation, access to certain of these grouping indexes is restricted to a specific group of users.

Preferably, for each entry Ei, each link Ui is associated with a weighting P1i determined as a function of the profile of the user originating the categories Ci associated with Ei.

In one embodiment, for each entry Ei, each link Ui is associated with a weighting P2i determined as a function of the position in the arborescence of the category Ci associated with Ei.

In addition, the description Ki is made up of at least one keyword attributed by reference to the name of the folder Ci.

According to one implementation method, the description Ki is made up of at least one keyword attributed by reference to the content of the links Ui grouped in the same category Ci.

### BRIEF DESCRIPTION OF THE DRAWINGS

The invention will be better understood by reading the following description, which concerns a non-limited implementation method, referring to the diagrams in the annex where:

FIG. 1 represents a global view of the system;

FIG. 2 represents the steps in the construction of the index;

FIG. 3 represents storing an arborescence;

FIG. 4 represents the distribution of the index over several computers; and

FIG. 5 represents the steps in querying the index

### DETAILED DESCRIPTION OF THE INVENTION

The current patent describes a social search engine based on the collecting and sharing of personal tree structures of users' links (social bookmarking) and the use of classification structures to determine the proximity relationship between the links.

The current invention belongs to a category of services known as social bookmarking. These services have a principle characteristic of facilitating the exchange between users the mechanism of serendipity. Certain services, like the current invention, add possibilities of collaborative search which are based on data collected by users of the system as opposed to “classical” search engines which index documents on the Internet network independently of the its users. The current invention differs from other bookmark management systems in that it is not based on the association of tags with links. Systems based on tagging suffer from the same difficulties as all search systems based on keywords: language problems, spelling and polysemy. Unlike systems based on tagging, the current invention is not based on the words associated with categories and links to calculate the proximity between links but on the hierarchical grouping of the links. This structural approach allows us to compensate for the set of problems mentioned above.

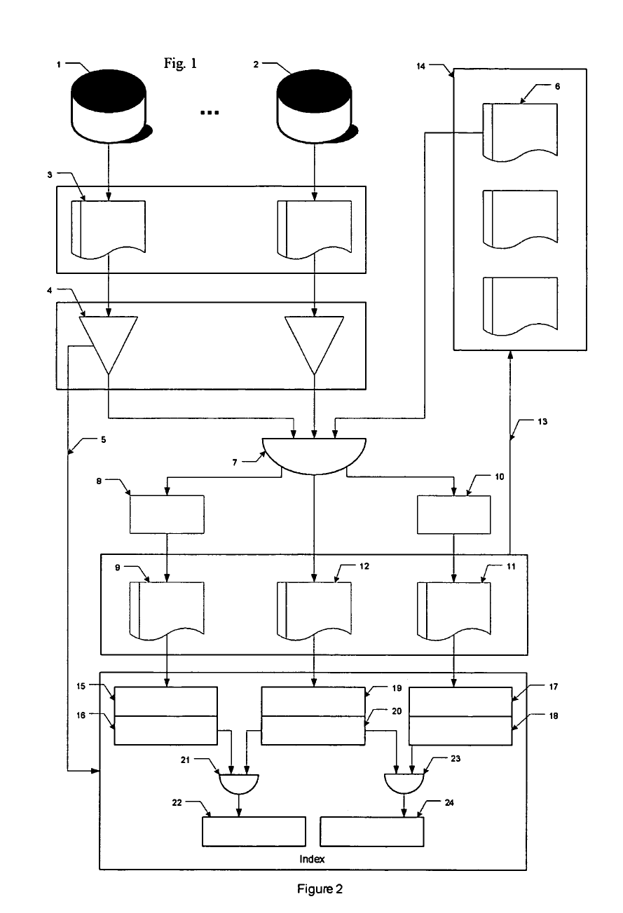

FIG. 1 represents a schematic view of a system implementing the invention.

It is made up of personal computers (1, 2) connected to a network, for example the Internet. Each personal computer (1, 2) is equipped with web navigation software (3) as well as software to watch and update favorites (4) communicate with a system of storage and indexation (5). This indexing system (5) explores a subset of the network (11) to analyze the resources referenced in the index and to collect associated meta-information.

The users use a computer (1,2) equipped with browsing software (3) to access web sites. From this browser, the users can record and classify web sites which attract their attention. A synchronization agent (4) detects in real time the changes made by the user to his personal web site arborescence. This agent communicates the changes to the favorites to the server platform (5) (creation, deletion, update). The font-end servers (6) handle the interface between synchronization agents (4) and the platform (5). A copy of the user arborescence is stored in the data base (7). The data bases (7) and the synchronization agents (4) also perform the function of synchronizing the user's favorites over several personal computers. Indexes (8) are created from the data bases (7). The construction of these indexes and searches therein are described in later chapters. The construction of the indexes can be associated with exploring a subset of the network (11), for example the Internet. Certain data of the index (title, activity, RSS . . . ) are determined from analysis of the sites (12) referenced by the users. These data extractions are carried out by the extraction robots or web crawlers (9) which query the web sites (12) at regular intervals. These robots are indispensable to determine the meta-information associated with the indexed links, for example: the “real” title of a page and not that given by a user, the availability of a page, the presence of one or more RSS feeds associated with the page. Another type of robot extraction (10) is used to supply the index by other sources (13). These sources all have in common that they are sufficiently structured to infer arborescence of the links which supply the index in an analogous way to the users' personal arborescence. Link directories (e.g. dmoz), blogs, RSS feeds . . . are examples of sources explored by the extraction robots (10).

Frontal servers and the storage data bases are not described in this document because their implementation does not present any difficulty in relation to the current state of the art.

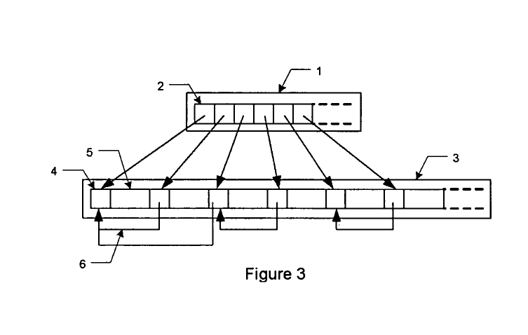

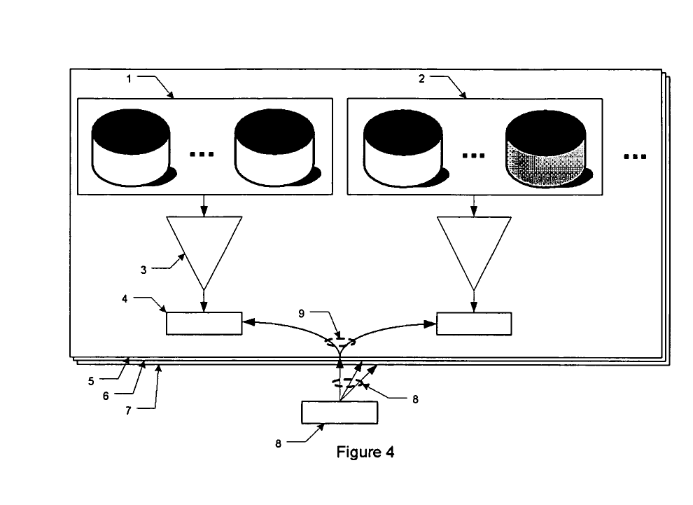

### Construction of the Index (FIGS. 2 and 3)

The construction of the index follows a complex process which is distributed over several computers in a network (pipeline) of processing and transformations described in FIG. 2. The personnel arborescences are stored in data bases (1,2). A differential extraction of user data (3) is carried out at regular intervals for each data base (1,2). These extractions are carried out based on the update dates of the user data, all data modified after the previous extraction will be integrated into the differential extraction file. The files (3) are organized in a line, each line is a tuple containing: a user identifier, a (hierarchical) referencing path, a URL link identifier and perhaps a title and a weighting which defines the importance of the link, a sharing flag. The content of the extracted files is sorted by increasing order of the user identification. This sort is used to facilitate and optimize the subsequent treatment in the pipeline. For each extracted file (3), a filtering process (4) is applied. The final objective of this filtering process is to improve the quality of the recommendations given by the engine and minimize the effect of spamming inherent in all search engines. Several techniques are put in place to carry out the filtering
Using a set of filtering rules based the referencing level in the hierarchy, the size of the categories, the reputation of the user, the frequency of referencing of sites, the accessibility of referenced links, user votes for a folder or a link, detection of folders predefined in web browsers, the frequency of updating of categories.
Use of existing indexes to determine the quality of user folders which are judged suspicious by applying the previous rules. This method of filtering uses a “retro-action” loop (5) linking the filtering processes to the previous version of the index to compare the suspect data and the community data. For example, for a group of links, (e.g. a category) it is possible to determine the level of correlation of the links one to another based on the number of common points of the neighbors of each link in the group. If the correlation level is near zero, then the folder will not be taken into account.

The filtering process (4) associates a weighting to each link depending on certain parameters: the source of the links, the user audience, and the reputation of the user. The data thus filtered are then associated with the data associated with the construction of the previous index (6). The association is carried out by a merge operation (7) user by user which uses the age of the data in case of conflict. The most recent data are given priority. The entries of the operator (7) are all ordered in the same way to simplify the implementation of this merge. The output of this merge operation (7), an ordered data stream is generated representing the current state of the data of a group of data bases (1,2). This stream is then distributed to three files. The first file (9) corresponds to the list of unique URLs referenced in the stream. Processing (8) then groups and parallel sorts to generate the file (9) from the output (7). The uniqueness and the order of the urls are not based directly on the urls themselves but on the normalized form of the urls. The normalization process transforms urls which are equivalent but written differently to a unique form (e.g. the urls http://www.site.com/index.html et http://www.site.com are normalized as a single representation http:site.com/). The normalization consists of applying transformation rules on the original url. The rules are:
Only http and https urls are recognized
The url is converted to lower case
Spaces before and after the url are removed (‘ ’ and ‘\t’)
Default ports are removed (:80 for http and :443 for https)
Anchors are removed
A slash is added to the end of a url if it does not contain one (e.g. http://www.google.com-->http://www.google.com/) and if it does not explicitly reference a document (e.g. http://www.site.com/doc.html-->http://www.site.com/doc.html)
Simplification of // and /./ to /
Resolve the relative addresses / ../, / .../ ...
Remove the // after the protocol (e.g. http://www.google.com/-->http:www.google.com/)
Remove the files index.* and default.* (eg: http://www.google.com/index.html-->http://www.google.com/)
Removed the prefix www.
Remove the session identifiers: PHPSESSID, sessionKey, P2CSESSID, jsessionid . . .

The second file (11) corresponds to the list of words used in the arborescence coming from the stream (5). The process (10) is used to create this file from:
The hierarchy category titles
The titles of the pages pointed to by the links
The words or a subset of the words from the content of the referenced links. The subset of words is obtained by classical methods of summarizing or extracting the most significant terms (e.g. statistical methods).

The processing (10) breaks down by words then carries out groupings and parallel sort to generate the file (11). The uniqueness and the word sort are based on word normalization. The transformation rules are:
The word is converted to lower case
Accents are replaced by non-accented equivalent if they exist.
Punctuation and non-numeric characters are replaced by spaces.

The third file (12) corresponds directly to the content of the output stream from the merge operator (7). The output from the construction of the index files (9), (11) and (12) replace (link 13) the equivalent files from the construction of the previous index (14).

The file (9) is then used to construct a binary structure (15,16) optimized and compressed which allows:
1. Storing the urls and their meta-data as compressed data.
2. Rapidly converting a normalized url to a numeric identification (url-id).
3. Rapidly converting a url-id to a url an its associated meta data.

The url compression (15) is based on the recurring presence of prefixes common to urls. The algorithms like Front Coded, Digital Trie or Judy Array can be used to carry out this compression. The conversion from url→url-id (16) is based on the algorithms of the type Minimal Perfect Hash, Digital Trie, HAMT or Judy Array.

In an analogous way, the system constructs an optimized and compressed binary structure (17,18) of the file (11). The conversion from keyword→keyword-id (18) preferably uses the algorithms of the type Digital Trie or the like to support searches on the prefixes.

The file (12) is used to construct a binary structure (19,20) optimized and compressed representing the user arborescence (category arborescence). Each category is associated with a unique numeric identification cat-id, the tree-like character is conserved. The categories are stored in a linear structure according to the composite ordering of user identification then the category path. FIG. 3 presents a synthetic view of this structure. This structure is composed of two linear sub-structures. The tabular structure (3.1) represents a succession of pointers to a tabular structure (3.3). The index of each element (3.2) corresponds to the identification of the category cat-id mentioned above. The content of (3.2) is a pointer or an offset in the structure (3.3). The input to the structure (3.1) follows the order defined (user id, path). The tabular structure (3.3) continually stores a binary representation of the arborescence of each indexed user. The element (3.4) codified over a series of bytes of the size of the following element (3.5) and a possible offset (3.6) on an element of type (3.4) corresponds to a parent category. This element of type (3.4) can be extended to codify supplementary information of type: user identification, shared category, weighting . . . . The element (3.5) represents the list of url-id presents in the current category (3.2). This list is compressed using arithmetic compression or Huffman. Links (3.6) are used to determine the relationship parent/child and child/parent which will be used in the case of the search at a level higher than one. To obtain the upper category of any category simply use the offset coded in (3.4). To obtain the list of sub-categories of a category, it is necessary to go up to the parent category P and then navigate the categories with a higher index which point to the category P, stopping at the first category with no higher category (change of user) limiting to possible sub-categories of P (use of a local map to detect the end of the sub-tree).

In FIG. 2, the file (12) and the index (16) are used together (21) to construct an inverse index (22) which means the correspondence url-id→list of cat-id can be rapidly obtained. The list of cat-id corresponds to the list of categories which contain the url identified by url-id. The list of the cat-id is compressed using the equivalent of the algorithms at point (3.5).

The file (12) and the index (18) are used jointly (23) to construct an inverse index (24) which enables us to rapidly obtain a correspondence keyword-id→list of cat-id. The list of cat-id corresponds to the list of categories which contain the word identified by url-id. The list of cat-id is compressed using the algorithms equivalents to point (3.5).

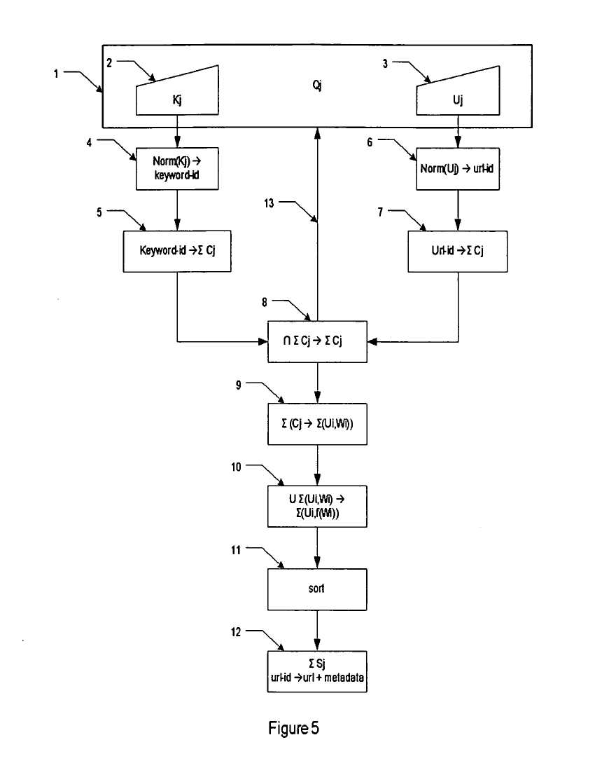

### Distribution of the Index (FIG. 4)

The distribution of the index allows the data and the queries to be distributed over several computers to obtain a progressive scalability. FIG. 4 presents the distribution mode used. The storage data bases (1,2) are associated by group (cluster) of fixed size. Independently, an index (4) is constructed for each group using construction steps described in the previous chapter. This construction phase is represented by the element (3) of FIG. 4. The distribution procedure is completed by a replication process which allows it to construct several instances of the same index group (5,6,7). To each instance, (5,6,7) a multicast post is associated to facilitate simultaneous querying of indexes present in the group. This distribution principle and the replication means that large indexes can be exploited.

In the index-querying phase (a phase described in detail in a later chapter), a process (8) is used to carry out a query on a group of indexes (6, 6 or 7). The choice (8) of group depends on a classical distribution algorithm. The process (8) carries out a multicast query (9) on the selected group index. The process (8) collects the results and carries out an operation to merge the results by applying a function f taking as parameters the various ranks of a same url and producing as an output a new ranking value for the url. The simplest function in this context is the addition k-ary. After the merge, a reordering of the links is carried out by decreasing order of rank.

### Querying of the Index (FIG. 5)

FIG. 5 described the querying process of an index which allows us to obtain a final list of recommended links Sj classed by decreasing order of their rank. The search can be carried out starting from various criteria Qj (1). A search can use criteria of type keyword Kj (2), criteria of type Uj (3) or a combination of the two. It is possible to specify several Kj (2) and several Uj (3).

If there is at least Kj in Qj then the branch Kj is used. For each Kj, the index (2.18) is used to convert the normalization of Kj (4) and its corresponding numerical identification. Subsequently, if there is a corresponding keyword-id, the structure (2.24) is used to determine the list of categories Cj which are targets of Kj (5).

If there is at least one Uj in Qj then the branch Uj is used. For each Uj, the index (2.16) is used to convert the normalization of Uj (6) to its corresponding numeric identification. Subsequently, if there is a corresponding url-id, the structure (2.22) is used to determine the list of categories Cj which are target of Uj (7).

The sets Cj from the multiples branches Kj and Cj are collected at the level of the processes (8) which performs an intersection of the sets of Cj. Output from the process (8) is obtained a set of Cj common to all the Kj/Uj or an empty set. If the result is an empty set this means that there is no response to the query, in this case the system changes to approximate search mode if it is not already (described below). The search process stops if it is already in approximate search mode.

If the set of Cj is not empty the process continues at stage (9). This step consists for each Cj of determining the set of couples Ui,Wi contained in the category Cj. The parameter Wi represents the weight of Ui in Cj. This weight is a function of the weight of the category Cj, the depth of Ui in Cj, the global popularity of Ui in the system, the reputation of the user who owns Cj. The transformation Cj→(Ui,Wi) is carried out from the structure (2.19,2.20). A simple case of the calculation of Wi can be given by the following principle:
dist(Cj,Ui)=1 iff Ui is in the category Cj
dist(Cj,Ui)=2 iff Ui is in the category parent(Cj) or in one of the categories directly lower than Cj (child (Cj)).
dist(U1,Ui)=3 iff Ui is in the parent category (parent(Cj)) or in one of the child categories (child(Cj)).
Recursively applying the previous distance calculation for the upper distances.
Wi(Ui,Cj)=1/dist(Cj,Ui)

The step (10) performs a union of the sets of the couplets Ui,Wi based on the key Ui to carry out the connection. A function f is used to make up the different Wi of a same Ui. We finally obtain a set of pairs (Ui,f(Wi)). By default the function f is a simple addition, it can be replaced by a function of type bayesienne average or any other function judged relevant in this context.

The step (11) sorts the pairs (Ui,f(Wi)) according to f(Wi) in decreasing order. The system only saves the first n results from the list. The parameter n being defined by the system or by the querying user.

The last step (12) consists of converting the Ui (numerical identification) into information useable by users. The Ui are thus converted into urls, title and associated meta data using the index described in (3.15,3.16).

The step (13) is carried out only if the search goes to approximate search mode (the case where (8) returns an empty set). The point of this mode is to extend the search perimeter and so find the results when the classical mode has failed. Its drawback is to diminish the pertinence of the results. The entries Qj undergo a transformation to extend the search perimeter:
The criteria Kj are extended using a search by prefix (of the type words starting with). Indexes of the type Digital Trie are used in this case.
The criteria Uj are transformed by applying the interlinked functions norm(reduce(url)). The function norm has already been presented. The reduce function consists of returning the more general url by progressively going back up the paths or folders which make it up (e.g. reduce(http://www.site.com/dossier/doc.html)=http://www.site.com).

After transforming the entries Qj, the search process picks up again at (4) and (6).

This chapter has described the basic principle of the search technique of the current patent. The following chapters describe the extensions or possible peripheral uses of this technique.

### Secondary Search Criteria

The criteria Kj and/or Uj are called primary because they are indispensable to launch a search. The system can nevertheless take into account the secondary search criteria as well as one or more primary criteria. There follows a few examples of secondary criteria which can be integrated into the index:
Date of discovery of the suggested links, information obtained when the url is added to the index for the first time.
The user group to restrict the search to a subset of categories Cj. By declaring membership of a group or community, a user shares his link arborescence with a group.
The language used in the document pointed to by the url, information obtained by the webcrawler (1.12).
The country associated with the domain name of the url, information obtained by analyzing the domain name or by querying a data base of IP localization.
Presence of one or several RSS feeds for a given url, information obtained by the webcrawler (1.12).

### Search Users or Groups of Users

Each user in the system can voluntarily join a group of users. The groups are created by the users themselves. A user can contribute to the group by referencing certain of his categories Cj in the group. Other functions are associated with this notion of a group, but they are not described in this patent.

The indexing and search system described above returns results made up of suggestions of links classified by decreasing order of rank. Based on the indexing principle presented it is possible to set out the searches which return other types of result:

From criteria Uj or Kj or a combination of these, it is possible to return the identifiers for the users associated with the categories issuing from the process (8) described in FIG. 5. This list of users corresponds to users which have referenced links related to the search criteria. The users are then classified by decreasing order of relevance. The relevance of a user is calculated from the number of subscriptions to his topics Cj. A more developed calculation of the relevance takes into consideration: the number of topics Cj, the number of shared links, the frequency of update of the topics Cj, the general profile of the user.
From criteria Uj or Kj or a combination of these criteria, it is possible to return identifiers for the groups of users associated with the categories Cj issuing from the process (8) described in FIG. 5. This list of groups of users corresponds to groups or communities which have referenced links in relation to the search criteria. The groups are then classified by decreasing order of the umber of subscribers.

### Use of the Index with Other Types of Sources

The indexation principle presented in this patent can apply to other types of content sources than the personal arborescence of the type favorites. In fact it is possible to apply this indexing principle to all sources where a categorization of links can be extracted with or without hierarchy. Depending on the type of source, the processing steps to extract the link categories are more or less direct. Here are a few examples of transformation:
The directories of centralized links built up by an organization or community of people (e.g. yahoo directory, dmoz) can be directly indexed by our technique.
Blogs or RSS information feeds are made up of articles or items which each contain a text and sometimes one or more links. Statistically the links contained in a blog article or an RSS item are generally linked thematically. The transformation consists of considering an article or an item as a category containing links. Only articles/items containing at least 2 links are retained. Other parameters can be taken into account to improve the indexing quality: size of the article, type of the link (internal/external). Certain blogs/rss support the notion of categories; in this case it is possible to exploit this information to construct a more detailed hierarchy of the links.

What is claimed is:

1. Documentation search procedure in a distributed information system, made up of construction steps of a thematic representation consisting of:
constructing, on user computers, thematic categories each containing at least one link to a documentary resource Ui, each category being associated with a description Ci, the resources Ui of a category being considered by the user as a homogenous in terms of their thematic content and associated with at least one descriptor Ki;
constructing at least one grouping index,
a first grouping index consisting of the entries Ei made up of all the access links Ui of the documentary resources, each entry Ei being associated with at least one category Ci of access links Ui,
a second grouping index consisting of entries Ei made up of all the descriptions Ki of the categories Ci made up of the access links Ui of the documentary resources, each entry Ei being associated with at least one category Ci of access links Ui,
and the search steps consisting of extracting from one of the grouping indexes, the categories Cj associated with at least one entry Ej corresponding to a search criteria Qj and to establish a list of suggestions Sj made up of the access links Uj ordered as a function of a score representing the importance and/or the number of occurrences of the link Uj in the categories Cj.

2. Documentary search procedure according to claim 1 wherein the category description Ci is made up of an identification of the user originating the category Ci.

3. Documentary search procedure in accordance with claim 1 wherein the description of the category Ci is made up of a coefficient representing the degree of pertinence of the category.

4. Documentary search procedure in accordance with claim 1 wherein the descriptor of the category Ci is made up of an identifier of at least a set of which category Ci belongs.

5. Documentary search procedure in accordance with claim 1 wherein the descriptor of the category Ci is made up of at least one link identifier Ui belonging to the category Ci.

6. Documentary search procedure in accordance with claim 1 wherein the search criteria Qj corresponds to at least one address recorded in at least one category Cj.

7. Documentary search procedure in accordance with claim 1 wherein the search criteria Qj corresponds to the address of a page being consulted.

8. Documentary search procedure in accordance with claim 1 wherein the search criteria Qj corresponds to at least one address present in the contents of a page being consulted.

9. Documentary search procedure in accordance with claim 1 wherein the search criteria Qj corresponds to at least one keyword present ing a form or a page being consulted.

10. Documentary search procedure in accordance with claim 1 wherein the access to certain grouping indexes is restrained to a specific group of users.

11. Documentary search procedure in accordance with claim 1 wherein, for each entry Ei, each link Ui is associated with a weight P1i determined as a function of the profile of the users originating the categories Ci associated with Ei.

12. Documentary search procedure in accordance with claim 1 wherein, for each entry Ei, each link Ui is associated with a weight P2i determined as a function of the position in the arborescence of the category Ci associated with Ei.

13. Documentary search procedure in accordance with claim 1 wherein the descriptor Ki is made up of at lest one keyword attributed by reference to the name of the folder Ci.

14. Documentary search procedure in accordance with claim 1 wherein the descriptor Ki is made up of at least one keyword attributed by referenced to the content of the links Ui grouped in the same category Ci.
